(19) United States
(12) Patent Application Publication
(10) Pub. No.: US 2024/0032158 A1
(43) Pub. Date: Jan. 25, 2024

(54) HEATING SYSTEM FOR WINDSHIELD

(71) Applicant: GM Global Technology Operations LLC, Detroit, MI (US)

(72) Inventors: Gerard Parij, Warren, MI (US); Omar Rodrigo Garcia Martinez, Tlalnepantla De Baz (MX); Jeevotham Bhat, Bangalore (IN); Rachit Garg, Bangalore (IN)

(21) Appl. No.: 17/872,576

(22) Filed: Jul. 25, 2022

(51) Int. Cl. H05B 3/86; H05B 3/06; B60J 1/00; B60S 1/02

(52) U.S. Cl. CPC H05B 3/86; H05B 3/06; B60J 1/002; B60S 1/026; H05B 2203/016; H05B 2203/013

(57) ABSTRACT

A vehicle, window of the vehicle and a heating system for a window. The window includes a first pane and a second pane. A conductive coating is disposed between the first pane and the second pane, the conductive coating extending through a primary vision zone of the window from a secondary bottom vision zone of the window to a secondary top vision zone of the window. A first electrical wire is connected to the conductive coating within the secondary bottom vision zone for flowing a current into the conductive coating to generate heat within the primary vision zone.

### INTRODUCTION

The subject disclosure relates to vehicle windshields and, in particular, to a system and method for defrosting and deicing windshields, but not excluding other locations in a vehicle such as backlites or side glass.

In various weather conditions, a windshield of a vehicle can accumulate ice, frost, fog, mist and other moisture conditions, which can occlude a driver's view through the windshield. Often a heating system is used to mitigate these conditions. For example, warm air can be supplied to the windshield from inside the cabin. Also, electricity can be run from a power supply (e.g., a 12-volt power supply) through electrical wires that extend across the windshield. These electrical wires are required to be thick enough or to be grouped in sufficient density to provide enough heating energy to the windshield to effectively mitigate the conditions in an appropriate amount of time. Due to the thickness requirements and/or density requirements, the electrical wires are often visible to the driver and are therefore not aesthetically pleasing. Accordingly, it is desirable to provide a heating system that can clear up moisture conditions without the need for wires that are distracting to the driver.

### SUMMARY

In one exemplary embodiment, a heating system for a window is disclosed. The heating system includes a conductive coating and a first electrical wire. The conductive coating is disposed between a first pane and a second pane of the window, the conductive coating extending through a primary vision zone of the window from a secondary bottom vision zone of the window to a secondary top vision zone of the window. The first electrical wire is connected to the conductive coating within the secondary bottom vision zone for flowing a current into the conductive coating to generate heat within the primary vision zone.

In addition to one or more of the features described herein, the heating system further includes a polyvinyl butyral layer (PVB layer) that bonds the first pane to the second pane, wherein the conductive coating and the first electrical wire are one of between the PVB layer and the first pane and between the PVB layer and the second pane. The heating system further includes a second electrical wire connecting to the conductive coating within the secondary top vision zone. The first electrical wire is connected to a first terminal of a power supply via a first bus bar along a lower edge of the window and the second electrical wire is connected to a second terminal of the power supply via a second bus bar along an upper edge of the window. The first electrical wire has a diameter of between about 15 microns and about 50 microns. The first electrical wire makes at least one of an oscillatory waveform defined within a plane and a straight line. The first electrical wire has a first resistivity and the conductive coating has second resistivity.

In another exemplary embodiment, a window of a vehicle is disclosed. The window includes a first pane, a second pane, a conductive coating and a first electrical wire. The conductive coating is disposed between the first pane and the second pane, the conductive coating extending through a primary vision zone of the window from a secondary bottom vision zone of the window to a secondary top vision zone of the window. The first electrical wire is connected to the conductive coating within the secondary bottom vision zone for flowing a current into the conductive coating to generate heat within the primary vision zone.

In addition to one or more of the features described herein, the window further includes a polyvinyl butyral layer (PVB layer) that bonds the first pane to the second pane, wherein the conductive coating and the first electrical wire are one of between the PVB layer and the first pane and between the PVB layer and the second pane. The window further includes a second electrical wire connecting to the conductive coating within the secondary top vision zone. The first electrical wire is connected to a first terminal of a power supply via a first bus bar along a lower edge of the window and the second electrical wire is connected to a second terminal of the power supply via a second bus bar along an upper edge of the window. The first electrical wire has a diameter of between about 15 microns and about 50 microns. The first electrical wire makes at least one of an oscillatory waveform defined within a plane and a straight line. The first electrical wire has a first resistivity and the conductive coating has second resistivity.

In yet another exemplary embodiment, a vehicle is disclosed. The vehicle includes a window having a first pane and a second pane, a conductive coating and a first electrical wire. The conductive coating is disposed between the first pane and the second pane, the conductive coating extending through a primary vision zone of the window from a secondary bottom vision zone of the window to a secondary top vision zone of the window. The first electrical wire is connected to the conductive coating within the secondary bottom vision zone for flowing a current into the conductive coating to generate heat within the primary vision zone.

In addition to one or more of the features described herein, the vehicle further includes a polyvinyl butyral layer (PVB layer) that bonds the first pane to the second pane, wherein the conductive coating and the first electrical wire are one of between the PVB layer and the first pane and between the PVB layer and the second pane. The vehicle further includes a second electrical wire connecting to the conductive coating within the secondary top vision zone. The first electrical wire is connected to a first terminal of a power supply via a first bus bar along a lower edge of the window and the second electrical wire is connected to a second terminal of the power supply via a second bus bar along an upper edge of the window. The first electrical wire has a diameter of between about 15 microns and about 50 microns. The first electrical wire makes at least one of an oscillatory waveform defined within a plane and a straight line.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in an illustrative embodiment;

FIG. 2 shows a front view of a windshield of the vehicle, in an illustrative embodiment;

FIG. 3 shows a side view of a cross section of the windshield at cut A-A in FIG. 2; and

FIG. 4 shows a cross-sectional view of the electrical components of FIG. 3 in an assembled windshield.

### DETAILED DESCRIPTION

The following description is merely exemplary in nature and is not intended to limit the present disclosure, its application or uses. It should be understood that throughout the drawings, corresponding reference numerals indicate like or corresponding parts and features.

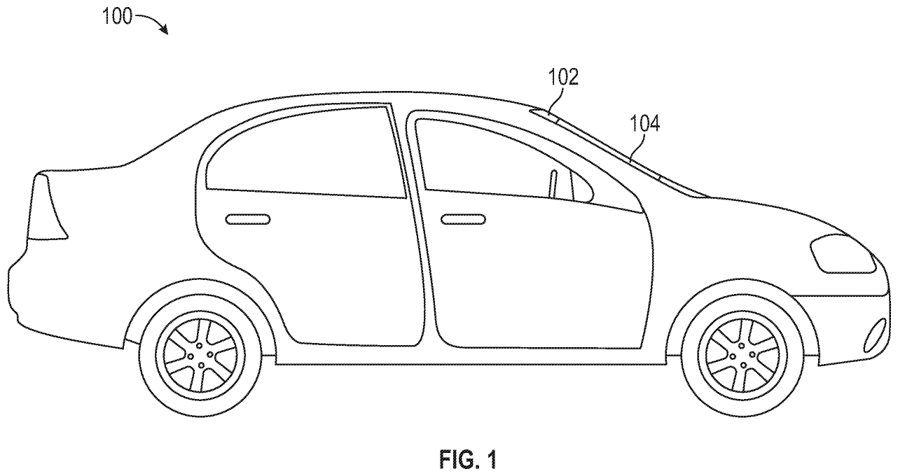

In accordance with an exemplary embodiment, FIG. 1 shows a vehicle 100. The vehicle 100 includes a windshield 102 having a heating system 104 disposed therein. The heating system 104 can be used for various purposes, such as to defrost the inner surface of the windshield 102, melt ice from the outer surface of the windshield, defog an inner surface of the windshield, etc. While discussed herein as being used in a windshield 102, the heating system 104 can be used on any suitable window, in alternate embodiments.

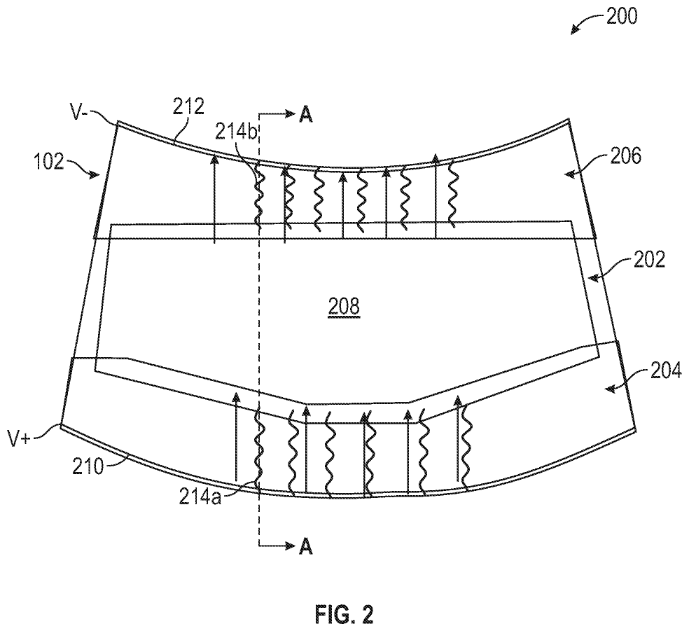

FIG. 2 shows a front view 200 of the windshield 102 of the vehicle 100. The windshield 102 depicts various zones, such as a primary vision zone 202, a secondary bottom vision zone 204 and a secondary top vision zone 206. The primary vision zone 202 is a region of the windshield 102 through which a driver or passenger expects to be able to see in order to operate the vehicle 100. The primary vision zone 202 includes a conductive coating 208 that forms a surface that covers the primary vision zone 202 but can also cover the entire windshield 102. The conductive coating 208 extends into the secondary bottom vision zone 204 and the secondary top vision zone 206. The conductive coating 208 is transparent, allowing the driver or passenger to see through. The conductive coating 208 is made of a material that generates heat when an electrical current is passed through it. In various embodiments, the conductive coating 208 includes silver.

The secondary bottom vision zone 204 is located below the primary vision zone 202. The secondary top vision zone 206 is located above the primary vision zone 202. The secondary bottom vision zone 204 includes a first bus bar 210 that runs along a lower edge of the windshield 102. The secondary top vision zone 206 includes a second bus bar 212 that runs along an upper edge of the windshield 102. The first bus bar 210 is a foil-like metal that connects to a first terminal of a power supply and the second bus bar 212 is a foil-like metal that connects to a second terminal of a power supply. The first terminal of the power supply can be a positive terminal (V+) and the second terminal of the power supply can be a negative terminal (V−). Alternatively, the first terminal can be a negative terminal (V−) and the second terminal can be a positive terminal (V+).

A plurality of first electrical wires 214a are connected to the first bus bar 210 and extend upward along the windshield 102 through the secondary bottom vision zone 204. The ends of the plurality of first electrical wires 214a that are distal to the first bus bar 210 remain within the secondary bottom vision zone 204 and do not extend into the primary vision zone 202. Similarly, a plurality of second electrical wires 214b are connected to the second bus bar 212 and extend downward along the windshield 102 through the secondary top vision zone 206. The ends of the plurality of second electrical wires 214b that are distal to the second bus bar 212 remain within the secondary top vision zone 206 and do not extend into the primary vision zone 202.

The first electrical wires 214a and the second electrical wires 214b are composed of conductive material, such as tungsten or copper or other suitable metals or alloy. In various embodiments, the diameters of the first electrical wires 214a and the second electrical wires 214b are in a range of between about 15 and about 50 microns, but other thicknesses can be considered in order to be less noticeable to the driver or passenger.

The first electrical wires 214a make respective contacts with the conductive coating 208 at a location within the secondary bottom vision zone 204. The second electrical wires 214b make respective contacts with the conductive coating 208 at a location within the secondary top vision zone 206. The first electrical wires 214a and second electrical wires 214b can be in the form of a wiggle wire. A wiggle wire makes a waveform defined within a plane. The waveform can be a sinusoidal waveform or other oscillatory waveform. In other embodiments, the first electrical wires 214a and second electrical wires 214b can be in the form of a straight line or a combination of a straight line and an oscillatory waveform.

Current from the power supply flows from the first bus bar 210 into the first electrical wires 214a and into the conductive coating 208. The current flows into the conductive coating 208 to generate heat within the primary vision zone 202 for melting ice, defrosting, etc. The current then flows out of the conductive coating 208 via the second electrical wires 214b and into the second bus bar 212. In various embodiments, the first electrical wires 214a and the second electrical wires 214b have a first resistivity and the conductive coating 208 has second resistivity. Section A-A in FIG. 2 is taken through the windshield 102 at the location at which a representative first electrical wire and a representative second electrical wire make electrical contacts with the conductive coating 208.

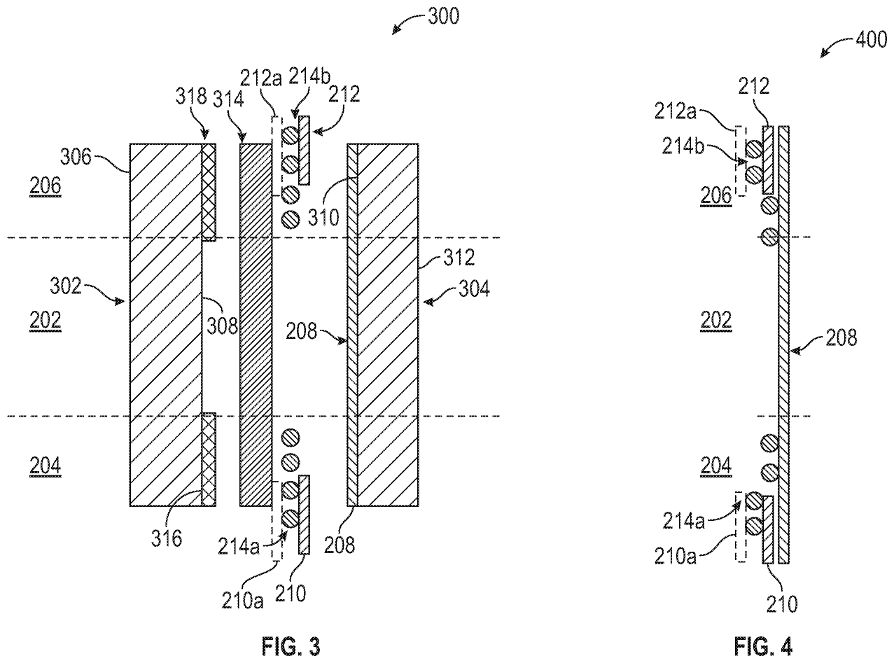

FIG. 3 shows a side view 300 of a cross section of the windshield 102 at cut A-A in FIG. 2, in an illustrative embodiment. The side view 300 shows a first pane 302 (e.g., inner pane) and a second pane 304 (e.g., outer pane) of the windshield 102. The first pane 302 has an outer surface (first surface 306) and an outer surface (second surface 308). The second pane 304 has an inner surface (third surface 310) and an outer surface (fourth surface 312).

A polyvinyl butyral layer (PVB layer 314) is disposed between the second surface 308 and the third surface 310 to bond the first pane 302 to the second pane 304. The conductive coating 208 can be in contact with either the second surface 308 or the third surface 310. For illustrative purposes, the conductive coating 208 is shown in contact with the third surface 310.

The first electrical wire 214a is shown adhered to a surface of the PVB layer 314 facing the third surface 310 within the secondary bottom vision zone 204. The second electrical wire 214b is shown adhered to the surface of the PVB layer 314 facing the third surface 310 within the secondary top vision zone 206. The first electrical wire 214a is sandwiched between the first bus bar 210 and the PVB layer 314 in the secondary bottom vision zone 204 and the second electrical wire 214b is sandwiched between the second bus bar 212 and the PVB layer 314 in the secondary top vision zone 206. In an alternate embodiment, an alternate first bus bar 210a can be sandwiched between the first electrical wire 214a and the PVB layer 314 and an alternate second bus bar 212a can be sandwiched between the second electrical wire 214b and the PVB layer. In yet another embodiment, both the first bus bar 210 and alternate first bus bar 210a can be used to sandwich the first electrical wire 214a and both the second bus bar 212 and alternate second bus bar 212a can be used to sandwich the second electrical wire 214b. The conductive coating 208 extends into the secondary bottom vision zone 204 at its lower end and into the secondary top vision zone 206 at its upper end. A first black enamel 316 or black decorative artwork in the secondary bottom vision zone 204 obscures the ability of the driver, passenger or observers from outside of the vehicle to see the first electrical wires 214a and a second black enamel 318 in the secondary top vision zone 206 obscures the ability of the driver, passenger or observers from outside of the vehicle to see the second electrical wires 214b.

FIG. 4 shows a cross-sectional view 400 of the electrical components of FIG. 3 once the windshield 102 is assembled, (i.e., once the first pane 302 is bonded to the second pane 304). The conductive coating 208 can make contact with the first bus bar 210 and the second bus bar 212. The first electrical wires 214a make an electrical connection from the first bus bar 210 to the conductive coating 208 in the secondary bottom vision zone 204 and the second electrical wires 214b make an electrical connection from the second bus bar 212 to the conductive coating 208 in the secondary top vision zone 206. As discussed with respect to FIG. 3, in alternate embodiments, alternate first bus bar 210a and alternate second bus bar 212a can be used as an alternative to, or in combination with, the first bus bar 210 and the second bus bar 212.

By extending the wiggle wires to the edges of their respective zones, the distance by which the current flows through the conductive coating is reduced or minimized, thereby increasing or maximizing the current density in the conductive coating. Although the conductive coating 208 can be in contact with the first bus bar 210 and the second bus bar 212, the first electrical wires 214a and the second electrical wires 214b provides a least resistive electrical path between their respective bus bars and the conductive coating 208. It is understood that the number of first electrical wires and second electrical wires, their areal density, their diameters, their material composition, their waveform, etc. are design parameters that can be decided by the manufacturer.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A heating system for a window, comprising:
a conductive coating disposed between a first pane and a second pane of the window, the conductive coating extending through a primary vision zone of the window from a secondary bottom vision zone of the window to a secondary top vision zone of the window; and
a first electrical wire connected to the conductive coating within the secondary bottom vision zone for flowing a current into the conductive coating to generate heat within the primary vision zone.

2. The heating system of claim 1, further comprising a polyvinyl butyral layer (PVB layer) that bonds the first pane to the second pane, wherein the conductive coating and the first electrical wire are one of: (i) between the PVB layer and the first pane; and (ii) between the PVB layer and the second pane.

3. The heating system of claim 1, further comprising a second electrical wire connecting to the conductive coating within the secondary top vision zone.

4. The heating system of claim 3, wherein the first electrical wire is connected to a first terminal of a power supply via a first bus bar along a lower edge of the window and the second electrical wire is connected to a second terminal of the power supply via a second bus bar along an upper edge of the window.

5. The heating system of claim 1, wherein the first electrical wire has a diameter of between about 15 microns and about 50 microns.

6. The heating system of claim 1, wherein the first electrical wire makes at least one of: (i) an oscillatory waveform defined within a plane; and (ii) a straight line.

7. The heating system of claim 1, wherein the first electrical wire has a first resistivity and the conductive coating has second resistivity.

8. A window of a vehicle, comprising:
a first pane;
a second pane;
a conductive coating disposed between the first pane and the second pane, the conductive coating extending through a primary vision zone of the window from a secondary bottom vision zone of the window to a secondary top vision zone of the window; and
a first electrical wire connected to the conductive coating within the secondary bottom vision zone for flowing a current into the conductive coating to generate heat within the primary vision zone.

9. The window of claim 8, further comprising a polyvinyl butyral layer (PVB layer) that bonds the first pane to the second pane, wherein the conductive coating and the first electrical wire are one of: (i) between the PVB layer and the first pane; and (ii) between the PVB layer and the second pane.

10. The window of claim 8, further comprising a second electrical wire connecting to the conductive coating within the secondary top vision zone.

11. The window of claim 10, wherein the first electrical wire is connected to a first terminal of a power supply via a first bus bar along a lower edge of the window and the second electrical wire is connected to a second terminal of the power supply via a second bus bar along an upper edge of the window.

12. The window of claim 8, wherein the first electrical wire has a diameter of between about 15 microns and about 50 microns.

13. The window of claim 8, wherein the first electrical wire makes at least one of: (i) an oscillatory waveform defined within a plane; and (ii) a straight line.

14. The window of claim 8, wherein the first electrical wire has a first resistivity and the conductive coating has second resistivity.

15. A vehicle, comprising:
a window having a first pane and a second pane;
a conductive coating disposed between the first pane and the second pane, the conductive coating extending through a primary vision zone of the window from a secondary bottom vision zone of the window to a secondary top vision zone of the window; and
a first electrical wire connected to the conductive coating within the secondary bottom vision zone for flowing a current into the conductive coating to generate heat within the primary vision zone.

16. The vehicle of claim 15, further comprising a polyvinyl butyral layer (PVB layer) that bonds the first pane to the second pane, wherein the conductive coating and the first electrical wire are one of: (i) between the PVB layer and the first pane; and (ii) between the PVB layer and the second pane.

17. The vehicle of claim 15, further comprising a second electrical wire connecting to the conductive coating within the secondary top vision zone.

18. The vehicle of claim 17, wherein the first electrical wire is connected to a first terminal of a power supply via a first bus bar along a lower edge of the window and the second electrical wire is connected to a second terminal of the power supply via a second bus bar along an upper edge of the window.

19. The vehicle of claim 15, wherein the first electrical wire has a diameter of between about 15 microns and about 50 microns.

20. The vehicle of claim 15, wherein the first electrical wire makes at least one of: (i) an oscillatory waveform defined within a plane; and (ii) a straight line.
